(19) United States
(12) Patent Application Publication
(10) Pub. No.: US 2023/0215715 A1
(43) Pub. Date: Jul. 6, 2023

(54) CALIBRATION OF ANALYTICAL INSTRUMENT

(71) Applicant: Micromass UK Limited, Wilmslow (GB)

(72) Inventor: Jason L. Wildgoose, Stockport (GB)

(73) Assignee: Micromass UK Limited, Wilmslow (GB)

(21) Appl. No.: 17/996,599

(22) PCT Filed: Apr. 20, 2021
(86) PCT No.: PCT/GB2021/050944

§ 371 Date: Oct. 19, 2022

(30) Foreign Application Priority Data
Apr. 20, 2020 (GB) 2005715.4

(51) Int. Cl. H01J 49/00; H01J 49/40; G01N 27/623

(52) U.S. Cl. CPC H01J 49/0009; H01J 49/40; H01J 49/004; G01N 27/623

(57) ABSTRACT

A method comprises measuring a first physico-chemical property of analyte ions so as to produce a data set, and identifying a first group of analyte ions within the data set. Analyte ions within the first group each have a value of an attribute that corresponds to a first value or that is within a first range of the attribute. The method further comprises selecting, from a plurality of different calibrations, a first calibration associated with the first value or first range of the attribute, and calibrating the measured first physico-chemical property of the first group of analyte ions using the first calibration.

### CROSS REFERENCE TO RELATED APPLICATION

This application claims priority from and the benefit of United Kingdom patent application No. 2005715.4 filed on 20 Apr. 2021. The entire content of this application is incorporated herein by reference.

### FIELD OF THE INVENTION

The present invention provides a method of calibrating an analytical instrument such as a mass and/or ion mobility spectrometer.

### BACKGROUND

Analytical instruments such as mass and/or ion mobility spectrometers are typically calibrated by ionising a calibrant compound, and then measuring a physico-chemical property (such as mass to charge ratio or ion mobility drift time) of the resulting ions. Measured physico-chemical property values are compared to reference physico-chemical property values, and differences between the measured values and the reference values are determined and used to determine a calibration for the instrument.

When an analyte is subsequently analysed using the analytical instrument, the analyte is ionised and the physico-chemical property of the resulting analyte ions is measured using the instrument. The calibration is then used to correct the measured physico-chemical property values of the analyte ions.

The Applicants believe that there remains scope for improvements to methods of calibrating analytical instruments.

### SUMMARY

According to an aspect, there is provided a method comprising:

measuring a first physico-chemical property of analyte ions so as to produce a data set;

identifying a first group of analyte ions within the data set, wherein analyte ions within the first group each have a value of an attribute that corresponds to a first value or that is within a first range of the attribute;

selecting, from a plurality of different calibrations, a first calibration associated with the first value or first range of the attribute; and

calibrating the measured first physico-chemical property of the first group of analyte ions using the first calibration.

Various embodiments relate to a method of calibrating an analytical instrument (such as a mass and/or ion mobility spectrometer) in which a data set (such as a mass and/or ion mobility spectrum) can be calibrated using multiple different calibrations. According to various embodiments, each calibration of the multiple different calibrations is associated with a different value or range of at least a first ion attribute, such as for example, a particular charge state, a value or range of a second physico-chemical property (such as ion mobility), and/or a value or range of initial ion energy. In various embodiments, one or more groups of analyte ions are identified in the data set (spectrum), such that ions within each group share the same value or are within a range of the (first) attribute. The data set (spectrum) is then calibrated by calibrating each group of ions in the data set separately using the calibration associated with the value or range of the (first) ion attribute of that group.

Thus, various embodiments are directed to a method of calibration in which multiple different calibrations are possible for a data set, and in which the particular calibration for a group of ions within the data set is selected depending on one or more determined attributes of those ions.

Various embodiments contrast with conventional techniques in which a single calibration is used for a data set. The Applicant has recognised that the use of plural different calibrations for a data set can result in a more accurate calibration.

As will be described in more detail below, this is because the initial conditions of ions which have the same intrinsic value of the first physico-chemical property (such as mass to charge ratio) can be different depending on the ions' attribute value(s) (such as charge state, second physico-chemical property (ion mobility) value, and/or initial ion energy), and these differences in initial conditions can cause differences in the measured first physico-chemical property (such as time of flight) of ions that have the same intrinsic value of the first physico-chemical property (mass to charge ratio).

In this regard, the Applicant has firstly recognised that it is possible to identify different groups of ions within a data set where ions in each group share the same or similar attribute value(s) (and therefore initial conditions) (even where at least some of the groups overlap in the first physico-chemical property), and secondly that by using a different calibration for each group, the differences in initial conditions (and so the differences in the measured first physico-chemical property) can be taken into account.

Thus, by identifying one or more groups of analyte ions within a data set where each group includes ions that have the same or similar attribute value(s), and selecting a calibration associated with the attribute value(s) of each group, the accuracy of the calibration can be increased.

It will accordingly be appreciated that various embodiments provide an improved method of calibrating an analytical instrument.

The method may comprise:

identifying a second different group of analyte ions within the data set, wherein analyte ions within the second group each have a value of the (first) attribute that corresponds to a second different value of the (first) attribute or that is within a second different range of the (first) attribute;

selecting, from the plurality of different calibrations, a second calibration associated with the second value or second range of the (first) attribute; and

calibrating the measured physico-chemical property of the second group of analyte ions using the second calibration.

According to an aspect, there is provided a method comprising:

measuring a first physico-chemical property of analyte ions so as to produce a data set;

using a first calibration to calibrate the measured first physico-chemical property of a first group of the analyte ions; and

using a second different calibration to calibrate the measured first physico-chemical property of a second different group of the analyte ions.

Analyte ions within the first group may each have a value of a first attribute that corresponds to a first value of the first attribute or that is within a first range of the first attribute. Analyte ions within the second group may each have a value of the first attribute that corresponds to a second different value of the first attribute or that is within a second different range of the first attribute.

Analyte ions within the first group may each have a value of a second (different) attribute that corresponds to a first value of the second attribute or that is within a first range of the second attribute. Analyte ions within the second group may each have a value of the second attribute that corresponds to a second different value of the second attribute or that is within a second different range of the second attribute.

The method may comprise using one or more third different calibrations to calibrate the measured first physico-chemical property of one or more third different groups of the analyte ions.

The method may comprise calibrating the data set using multiple different calibrations to obtain a calibrated data set.

The method may comprise determining a plurality of different calibrations for an analytical instrument, where each calibration of the plurality of different calibrations is associated with a respective different value or range of the (first) attribute.

Each calibration of the plurality of different calibrations may also be associated with a respective different value or range of the second attribute.

According to an aspect, there is provided a method comprising:

ionising a calibrant so as to produce ions;

using an analytical instrument to measure a first physico-chemical property of the ions;

for each reference value of a first group of reference values of the first physico-chemical property, determining a difference between the reference value and a measured value of the first physico-chemical property associated with that reference value, and determining a first calibration for the analytical instrument using the differences; and

for each reference value of a second group of reference values of the first physico-chemical property, determining a difference between the reference value and a measured value of the first physico-chemical property associated with that reference value, and determining a second calibration for the analytical instrument using the differences.

Reference values within the first group of reference values may correspond to ions which have a value of the (first) attribute that corresponds to a first value of the (first) attribute or that is within a first range of the (first) attribute. Reference values within the second group of reference values may correspond to ions which have a value of the (first) attribute that corresponds to a second different value of the (first) attribute or that is within a second different range of the (first) attribute.

Reference values within the first group of reference values may correspond to ions which have a value of a second (different) attribute that corresponds to a first value of the second attribute or that is within a first range of the second attribute. Reference values within the second group of reference values may correspond to ions which have a value of the second attribute that corresponds to a second different value of the second attribute or that is within a second different range of the second attribute.

The method may comprise:

for each reference value of a third group of plural reference values of the first physico-chemical property, determining a difference between the reference value and a measured value of the first physico-chemical property associated with that reference value, and determining a third calibration for the analytical instrument using the differences.

Reference values within the third group of reference values may correspond to ions which have a value of the (first) attribute that corresponds to a third different value of the (first) attribute or that is within a third different range of the (first) attribute. Reference values within the third group of reference values may correspond to ions which have a value of the second attribute that corresponds to a third different value of the second attribute or that is within a third different range of the second attribute.

The first physico-chemical property may comprise mass to charge ratio, time of flight, ion mobility and/or collision cross section.

The first physico-chemical property may comprise mass to charge ratio and/or time of flight, and the step of measuring the first physico-chemical property of the ions may comprise mass analysing the ions so as to produce a mass and/or time of flight spectrum.

The step of measuring the first physico-chemical property of the ions may comprise mass analysing the ions using a Time of Flight (“ToF”) mass analyser.

The first and/or second attribute may comprise a second (optionally different) physico-chemical property. At least one (such as the first) attribute may comprise a second different physico-chemical property (that is, a physico-chemical property that is different to (not the same as) the first physico-chemical property).

The first and/or second attribute may comprise charge state. Ions within each group may have the same charge state, and each group may correspond to a different charge state.

The first and/or second attribute may comprise mass to charge ratio, time of flight, ion mobility and/or collision cross section.

Ions within each group may have an ion mobility value and/or collision cross section within the same range, and each group may correspond to a different ion mobility and/or collision cross section range.

Ions within each group may have a mass to charge ratio and/or time of flight within the same range, and each group may correspond to a different mass to charge ratio and/or time of flight range.

The first and/or second attribute may comprise energy.

The first attribute may comprise ion mobility value and/or collision cross section and the second attribute may comprise mass to charge ratio and/or time of flight.

According to an aspect, there is provided an analytical instrument configured to perform the method described above.

The analytical instrument may comprise a mass and/or ion mobility spectrometer.

According to an aspect, there is provided a method comprising:

measuring a population of ions with a Time of Flight Mass Spectrometer (“ToFMS”);

identifying ions with specific attributes and/or characteristics; and

applying calibrations based on said attributes and/or characteristics.

### BRIEF DESCRIPTION OF THE DRAWINGS

Various embodiments of the present invention will now be described, by way of example only, and with reference to the accompanying drawings in which:

FIG. 1 shows schematically an analytical instrument in accordance with various embodiments;

FIG. 2 shows schematically a Time of Flight (“ToF”) mass analyser in accordance with various embodiments;

FIG. 3 shows mass accuracy versus mass to charge ratio data for singly, doubly, and triply charged ions measured using a Time of Flight mass spectrometer (“ToF-MS”);

FIG. 4 shows conceptually a multidimensional drift time-m/z data set;

FIG. 5 is a flow diagram illustrating a method of calibration in accordance with various embodiments; and

FIG. 6 is a flow diagram illustrating a method of determining a plurality of calibrations in accordance with various embodiments.

### DETAILED DESCRIPTION

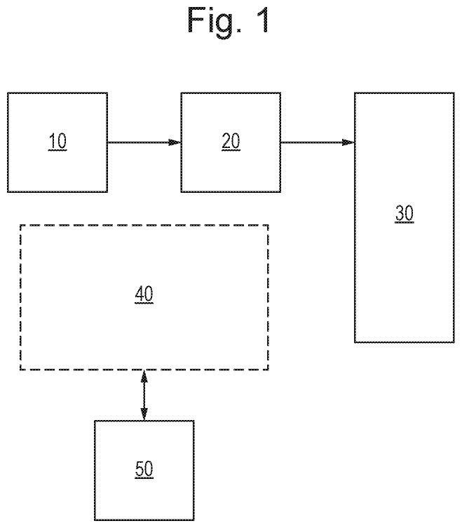

FIG. 1 shows schematically an analytical instrument such as a mass and/or ion mobility spectrometer in accordance with various embodiments. As shown in FIG. 1, the analytical instrument comprises an ion source 10, one or more functional components 20 that are arranged downstream from the ion source 10, and an analyser 30 that is arranged downstream from the ion source 10 and from the one or more functional components 20.

As illustrated by FIG. 1 the analytical instrument may be configured such that ions can be provided by (sent from) the ion source 10 to the analyser 30 via the one or more functional components 20.

The ion source 10 may be configured to generate ions, for example by ionising a calibrant or an analyte. The ion source 10 may comprise any suitable ion source such as an ion source selected from the group consisting of: (i) an Electrospray ionisation (“ESI”) ion source; (ii) an Atmospheric Pressure Photo Ionisation (“APPI”) ion source; (iii) an Atmospheric Pressure Chemical Ionisation (“APCI”) ion source; (iv) a Matrix Assisted Laser Desorption Ionisation (“MALDI”) ion source; (v) a Laser Desorption Ionisation (“LDI”) ion source; (vi) an Atmospheric Pressure Ionisation (“API”) ion source; (vii) a Desorption Ionisation on Silicon (“DIOS”) ion source; (viii) an Electron Impact (“EI”) ion source; (ix) a Chemical Ionisation (“CI”) ion source; (x) a Field Ionisation (“FI”) ion source; (xi) a Field Desorption (“FD”) ion source; (xii) an Inductively Coupled Plasma (“ICP”) ion source; (xiii) a Fast Atom Bombardment (“FAB”) ion source; (xiv) a Liquid Secondary Ion Mass Spectrometry (“LSIMS”) ion source; (xv) a Desorption Electrospray Ionisation (“DESI”) ion source; (xvi) a Nickel-63 radioactive ion source; (xvii) an Atmospheric Pressure Matrix Assisted Laser Desorption Ionisation ion source; (xviii) a Thermospray ion source; (xix) an Atmospheric Sampling Glow Discharge Ionisation (“ASGDI”) ion source; (xx) a Glow Discharge (“GD”) ion source; (xxi) an Impactor ion source; (xxii) a Direct Analysis in Real Time (“DART”) ion source; (xxiii) a Laserspray Ionisation (“LSI”) ion source; (xxiv) a Sonicspray Ionisation (“SSI”) ion source; (xxv) a Matrix Assisted Inlet Ionisation (“MAII”) ion source; (xxvi) a Solvent Assisted Inlet Ionisation (“SAII”) ion source; (xxvii) a Desorption Electrospray Ionisation (“DESI”) ion source; (xxviii) a Laser Ablation Electrospray Ionisation (“LAESI”) ion source; (xxix) a Surface Assisted Laser Desorption Ionisation (“SALDI”) ion source; (xxx) a Low Temperature Plasma (“LTP”) ion source; (xxxi) a Helium Plasma Ionisation (“HePI”) ion source; (xxxii) a Rapid Evaporative Ionisation Mass Spectrometry (“REIMS”) ion source; and/or (xxxiii) a Laser Assisted Rapid Evaporative Ionisation Mass Spectrometry (“LA-REIMS”) ion source.

In various particular embodiments, the ion source 10 comprises an Electrospray Ionisation (“ESI”) ion source.

The analytical instrument may comprise a chromatography or other separation device (not shown in FIG. 1) upstream of (and coupled to) the ion source 10. The chromatography separation device may comprise a liquid chromatography or gas chromatography device. Alternatively, the separation device may comprise: (i) a Capillary Electrophoresis (“CE”) separation device; (ii) a Capillary Electrochromatography (“CEC”) separation device; (iii) a substantially rigid ceramic-based multilayer microfluidic substrate (“ceramic tile”) separation device; or (iv) a supercritical fluid chromatography separation device.

The analyser 30 may be configured to analyse ions, so as to determine (measure) one or more of their physico chemical properties, such as their mass to charge ratio, time of flight, (ion mobility) drift time and/or collision cross section (CCS).

The analyser 30 may comprise a mass analyser (that is configured to determine the mass to charge ratio or time of flight of ions) and/or an ion mobility analyser (that is configured to determine the ion mobility drift time or collision cross section (CCS) of ions).

Where the analyser 30 comprises a mass analyser, the mass analyser may comprise any suitable mass analyser such as a mass analyser selected from the group consisting of: (i) a quadrupole mass analyser; (ii) a 2D or linear quadrupole mass analyser; (iii) a Paul or 3D quadrupole mass analyser; (iv) a Penning trap mass analyser; (v) an ion trap mass analyser; (vi) a magnetic sector mass analyser; (vii) Ion Cyclotron Resonance (“ICR”) mass analyser; (viii) a Fourier Transform Ion Cyclotron Resonance (“FTICR”) mass analyser; (ix) an electrostatic mass analyser arranged to generate an electrostatic field having a quadro-logarithmic potential distribution; (x) a Fourier Transform electrostatic mass analyser; (xi) a Fourier Transform mass analyser; (xii) a Time of Flight mass analyser; (xiii) an orthogonal acceleration Time of Flight mass analyser; and (xiv) a linear acceleration Time of Flight mass analyser.

In various particular embodiments, the analyser 30 comprises a Time of Flight mass analyser.

The one or more functional components 20 may comprise any suitable such components, devices and functional elements of an analytical instrument (mass and/or ion mobility spectrometer).

For example, in various embodiments, the one or more functional components 20 comprise one or more ion guides, one or more ion traps, and/or one or more mass filters, for example which may be selected from the group consisting of: (i) a quadrupole mass filter; (ii) a 2D or linear quadrupole ion trap; (iii) a Paul or 3D quadrupole ion trap; (iv) a Penning ion trap; (v) an ion trap; (vi) a magnetic sector mass filter; (vii) a Time of Flight mass filter; and (viii) a Wien filter.

The one or more functional components 20 may comprise an activation, collision, fragmentation or reaction device configured to activate, fragment or react ions so as to produce fragment or product ions.

The one or more functional components 20 may comprise an ion mobility separator configured to separate ions according to their ion mobility. The ion mobility separator may comprise a linear ion mobility separator, or a closed loop (cyclic) ion mobility separator.

The analytical instrument may be operated in various modes of operation including a mass spectrometry (“MS”) mode of operation; a tandem mass spectrometry (“MS/MS”) mode of operation; a mode of operation in which parent or precursor ions are alternatively fragmented or reacted so as to produce fragment or product ions, and not fragmented or reacted or fragmented or reacted to a lesser degree; a Multiple Reaction Monitoring (“MRM”) mode of operation; a Data Dependent Analysis (“DDA”) mode of operation; a Data Independent Analysis (“DIA”) mode of operation; a Quantification mode of operation; or an Ion Mobility Spectrometry (“IMS”) mode of operation.

It should be noted that FIG. 1 is merely schematic, and that the analytical instrument may (and in various embodiments does) include other components, devices and functional elements to those shown in FIG. 1.

As shown in FIG. 1, the analytical instrument may comprise a control system 40, that may be configured to control the operation of the analytical instrument, for example in the manner of the various embodiments described herein. The control system may comprise suitable control circuitry that is configured to cause the instrument to operate in the manner of the various embodiments described herein. The control system may comprise suitable processing circuitry configured to perform any one or more or all of the necessary processing and/or post-processing operations in respect of the various embodiments described herein. In various embodiments, the control system may comprise a suitable computing device, a microprocessor system, a programmable FPGA (field programmable gate array), and the like.

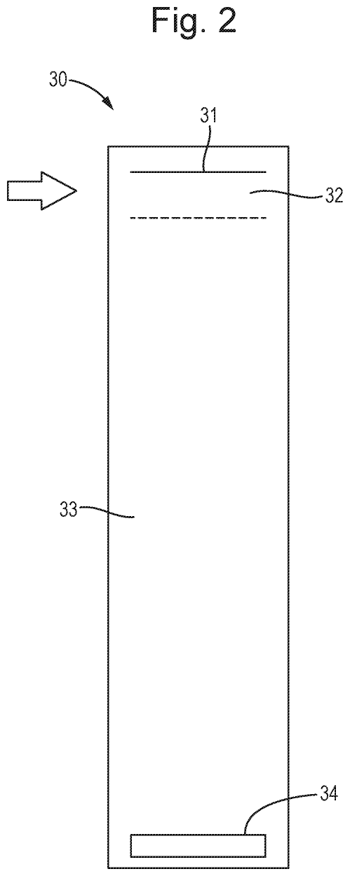

FIG. 2 shows in more detail a Time of Flight (“ToF”) mass analyser 30 according to various embodiments.

Ions may be supplied to the mass analyser 30 via the one or more functional components 20 upstream of the mass analyser 30. Prior to being introduced to the analyser 30, ions may be “thermalized” (so that all of the ions have the same thermal energy), for example by collisional cooling with a gas filled region (of the one or more functional components 20) upstream of the analyser 30.

As illustrated in FIG. 2, the mass analyser 30 may comprise an acceleration electrode 31 (such as a pusher and/or puller electrode), an acceleration region 32, a field free or drift region 33, and an ion detector 34 arranged at the exit region of the field free or drift region 33.

It should be noted here that FIG. 2 is merely schematic, and that other Time of Flight (“ToF”) mass analyser arrangements, such as a reflectron arrangement, a multi-reflecting Time of Flight (“mr-ToF”) arrangement, and the like, may be used. Thus, although not shown in FIG. 2, in various embodiments the mass analyser 30 may also comprise a reflectron (in which case the detector 34 may optionally be located adjacent the acceleration electrode 31) and/or one or more ion mirrors, for example.

Ions from one or more upstream stages 20 of the instrument may be arranged to enter the acceleration region 32 where they may be driven into the field free or drift region 33 by application of a voltage pulse to the acceleration (pusher) electrode 31. The ions may be accelerated to a velocity determined by the energy imparted by the voltage pulse and the mass to charge ratio of the ions. Ions having a relatively low mass to charge ratio achieve a relatively high velocity and reach the ion detector 34 prior to ions having a relatively high mass to charge ratio.

Ions may arrive at the ion detector 34 after a time determined by their velocity and the distance travelled, which enables the mass to charge ratio of the ions to be determined. Each ion or groups of ions arriving at the detector 34 may be sampled by the detector 34, and the signal from the detector 34 may be digitised. A processor may then determine a value indicative of the time of flight and/or mass-to-charge ratio (“m/z”) of the ion or group of ions. Data for multiple ions may be collected and combined to generate a data set comprising a Time of Flight (“ToF”) spectrum and/or a mass spectrum.

According to various embodiments, for each ion or group of ions arriving at the detector 34, the detector 34 will produce one or more signals, which may then be digitised and converted into time-intensity pairs, that is, data values comprising a time-of-flight value together with an intensity value. In these embodiments, multiple such time-intensity pairs may be collected and combined to generate a data set comprising a Time of Flight (“ToF”) spectrum and/or a mass spectrum.

Various embodiments are directed to a method of calibrating an analytical instrument such as the analytical instrument of FIG. 1. Various embodiments are directed to a method of calibrating an analytical instrument comprising a mass analyser such as a Time of Flight (“ToF”) mass analyser such as the Time of Flight (“ToF”) mass analyser of FIG. 2.

In Time of Flight (“ToF”) mass analyser (and other) arrangements, a calibration profile such as a calibration curve may be used to determine mass to charge ratio from measured time of flight. Additionally or alternatively, a conversion profile such as a conversion curve may be used to determine mass to charge ratio from measured time of flight, and then a calibration profile such as a calibration curve may be used to determine calibrated (more accurate) mass to charge ratio values.

In conventional arrangements, a single calibration curve is typically used to calibrate a data set (mass spectrum) across its entire (mass to charge ratio) range.

Various embodiments, however, relate to a method of calibrating an analytical instrument in which a data set (such as a mass spectrum) can be calibrated using multiple different calibrations (such as by using multiple different calibration curves). The Applicant has recognised that the use of plural different calibrations for a data set (mass spectrum) can result in a more accurate calibration.

This is because the initial conditions of ions which have the same intrinsic value of the first physico-chemical property (such as the same intrinsic mass to charge ratio) can be different depending on the ions' attribute value (such as charge state, second physico-chemical property (such as ion mobility) value, and/or initial ion energy), and these differences in initial conditions can cause differences in the measured first physico-chemical property (such as time of flight) of ions that have the same intrinsic value of the first physico-chemical property (such as mass to charge ratio).

For example, the initial position or spread of positions of ions within the acceleration region 32 (relative to the acceleration electrode 31) which have the same value of mass to charge ratio can be different depending on the ions' attribute value (such as charge state, second physico-chemical property (such as ion mobility) value, and/or initial ion energy), and these differences in initial position or spread of positions can cause differences in the measured time of flight (and so the measured mass to charge ratio) of ions that have the same intrinsic value of mass to charge ratio.

In this regard, the Applicant has firstly recognised that it is possible to identify different groups of ions within a data set (such as a mass spectrum) where ions in each group share the same or similar attribute value (and therefore initial conditions) (even where at least some of the groups overlap in the first physico-chemical property (such as mass to charge ratio)), and secondly that by using a different calibration for each group, the differences in initial conditions (and so the difference in the measured first physico-chemical property) can be taken in account and corrected.

Thus, in accordance with various embodiments, a first physico-chemical property of analyte ions is measured so as to produce a data set, and at least a first group of analyte ions is identified within the data set. Analyte ions within the first group may each have a value of an attribute that corresponds to a first value or that is within a first range of the attribute. A first calibration associated with the first value or first range of the attribute is then selected from a plurality of different calibrations, and the measured first physico-chemical property of the first group of analyte ions is calibrated using the first calibration.

For example, the time of flight and/or mass to charge ratio of analyte ions may be measured so as to produce a time of flight and/or mass spectrum, and at least a first group of analyte ions may be identified within the spectrum. Analyte ions within the first group may each have a value of an attribute (such as charge state, second physico-chemical property (such as ion mobility) value, and/or initial ion energy) that corresponds to a first value or that is within a first range of the attribute. A first calibration associated with the first value or first range of the attribute may then be selected from a plurality of different calibrations, and the measured time of flight and/or mass to charge ratio of the first group of analyte ions may be calibrated using the first calibration.

According to various embodiments, multiple different calibrations are provided, where each calibration of the multiple different calibrations is associated with a different value or range of the ion attribute, such as for example, a particular charge state, a value or range of a second physico-chemical property (such as ion mobility), and/or a value or range of initial ion energy. In various embodiments, plural different groups of analyte ions are identified in the data set, such that ions within each group share the same value or are within a range of the attribute. Each group of ions is then calibrated separately using the calibration associated with the value or range of the ion attribute of that group.

Thus, a second, third and/or further different group of analyte ions may also be identified within the data set. Analyte ions within the second, third and/or further group may each have a value of the attribute that corresponds to a second, third and/or further different value or that is within a second, third and/or further different range of the attribute. A second, third and/or further calibration associated with the second, third and/or further value or second, third and/or further range of the attribute may then be selected from the plurality of different calibrations, and the measured first physico-chemical property of the second, third and/or further group of analyte ions may be calibrated using the second, third and/or further calibration.

For example, a second, third and/or further different group of analyte ions may also be identified within the time of flight and/or mass spectrum. A second, third and/or further calibration associated with the second, third and/or further value or second, third and/or further range of the attribute may then be selected from the plurality of different calibrations, and the measured time of flight and/or mass to charge ratio of the second, third and/or further group of analyte ions may be calibrated using the second, third and/or further calibration

Thus, various embodiments are directed to a method of calibration in which multiple different calibrations are possible for a data set, and in which the particular calibration for a group of ions within the data set is selected depending on a determined attribute of those ions. By identifying one or more groups of analyte ions within a data set where each group includes ions that have the same or similar attribute value, and selecting a calibration associated with the attribute value of each group, the accuracy of the calibration can be increased. Thus, various embodiments allow increased (mass) accuracy.

In various further embodiments, ions may be identified as being within a particular group based on more than one attribute. For example, for multidimensional data (such as mass to charge ratio (m/z)-mobility) data, a different calibration may be applied to different regions of the multidimensional (such as m/z-mobility) space.

Thus, the method may comprise identifying the first group of analyte ions within the data set, wherein analyte ions within the first group each have a value of a first attribute that corresponds to a first value or that is within a first range of the first attribute, and wherein analyte ions within the first group each have a value of a second (different) attribute that corresponds to a first value or that is within a first range of the second attribute. The method may comprise selecting, from a plurality of different calibrations, a first calibration associated with the first value or first range of the first attribute and with the first value or first range of the second attribute.

The method may comprise identifying the second different group of analyte ions within the data set, wherein analyte ions within the second group each have a value of the first attribute that corresponds to a second different value or that is within a second different range of the first attribute, and wherein analyte ions within the second group each have a value of the second attribute that corresponds to a second different value or that is within a second different range of the second attribute. The method may comprise selecting, from the plurality of different calibrations, a second calibration associated with the second value or second range of the first attribute and with the second value or second range of the second attribute.

The method may comprise identifying the third different group of analyte ions and so on in a corresponding manner.

In these embodiments, the first attribute and the second attribute may each comprise any one of the attributes described herein. In various embodiments, at least one (such as the first) attribute comprises a second different physico-chemical property (that is, a physico-chemical property that is different to (not the same as) the first physico-chemical property). In various embodiments, the first attribute comprises ion mobility value and/or collision cross section and the second attribute comprises mass to charge ratio and/or time of flight.

Various embodiments are particularly suited for use in high mass accuracy systems, such as for example multi-reflecting time of flight (“mr-ToF”) arrangements.

In these (and other) arrangements, the initial conditions (position/spatial distribution) of the ions at the acceleration electrode 31 may limit the mass accuracy (rather than the ToF itself). This is because, even if ions arriving at the acceleration electrode 31 are fully thermalized (that is, have the same thermal energy), the initial conditions can be different depending on different attributes of the ions.

For example, in Time-of-Flight mass spectrometers (“ToF-MS”) (and elsewhere), ions are typically introduced into the analyser 30 from a gas filled RF confinement device such as an RF ion guide. This device may act to condition the ion beam so as to improve the resolution versus transmission characteristics of the spectrometer.

The initial conditions of ions can subtly depend on the attributes of the ions within the ion beam such as, amongst other things, mass, charge state (z), mass to charge ratio (“m/z”), ion mobility, energy, and combinations of these. Although this variation in initial conditions may have minimal effect on the resolution versus sensitivity profile of the instrument, the Applicant has recognised that it can significantly affect mass to charge ratio (“m/z”) calibration.

For example, a calibration based on singly charged ions may not be optimum when measuring doubly charged ions. This is because, ions having different charge states (but the same mass to charge ratio (“m/z”)) will arrive at the acceleration electrode 31 with different spatial distributions.

This is because after thermalization, all the ions will have the same energy (corresponding to the temperature of the thermalizing gas). Kinetic energy is proportional to mass (m) and to velocity squared (v²). So, larger ions (greater mass) will have smaller velocity (v), and so smaller spatial distribution in the gas filled region prior to the (ToF) mass analyser 30. This then means that, for ions having the same mass to charge ratio (“m/z”), those ions with greater charge (z) (and so greater mass (m)) will have a smaller spatial distribution than those ions with less charge (and so less mass).

So, in this case, the conventional assumption that ions having the same mass to charge ratio (“m/z”) will have the same flight time does not hold (because of different initial positions for ions of different charge but the same mass to charge ratio (“m/z”)).

It will accordingly be appreciated that the average time of flight for a population of ions in a ToF analyser is not only dependent on their mass to charge ratio (“m/z”). It also depends on the initial phase space within the acceleration region 32. This in turn depends on other attributes of the ions such as charge state, ion mobility and axial energy due to the nature of RF confinement. Even for thermalized ions, this can lead to differences in time of flight of hundreds of ppb for ions of the same mass to charge ratio (“m/z”) but different charge states. (This problem becomes worse for non-thermalized ions, as will be described further below).

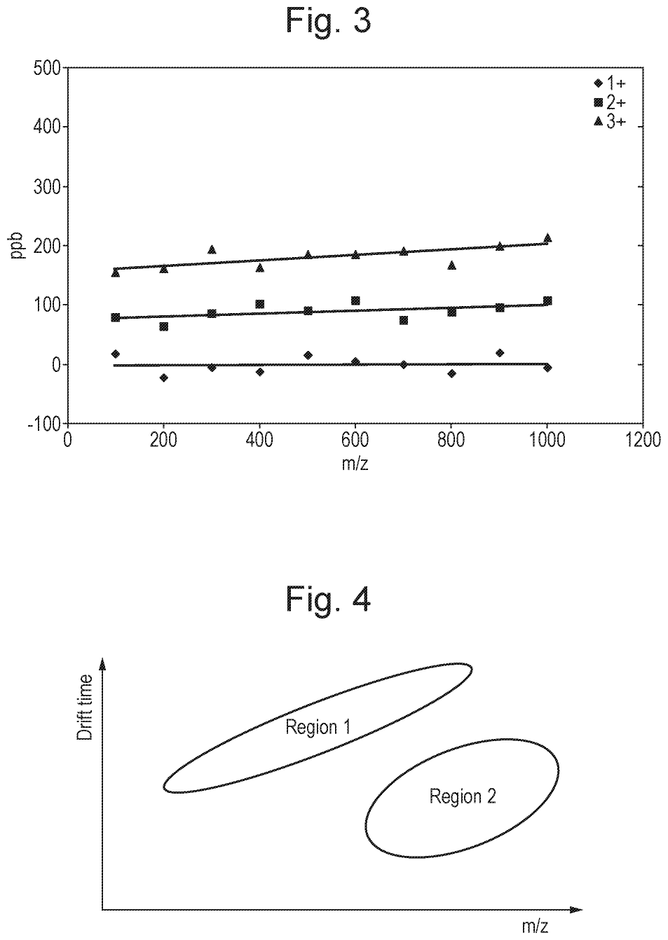

This is illustrated by FIG. 3, which shows mass accuracy versus mass to charge ratio data for singly, doubly and triply charged ions measured using a time of flight mass spectrometer. As can be seen from FIG. 3, the accuracy of the singly charged ions, doubly charged ions, and triply charged ions are all different. It can moreover be seen from FIG. 3 that each group of ions can be accurately calibrated using a respective different calibration curve (solid lines in FIG. 3).

Various embodiments are also or instead particularly suited for use in lower accuracy instruments, in particular where all of the ions may not have been fully thermalized before reaching the (ToF) mass analyser 30.

With the drive towards smaller, cheaper instruments the performance is inevitably compromised. Typically, one of the first performance figures to suffer is mass accuracy. This can be the case, for example, in instruments which have relatively short gas filled regions prior to the mass analyser 30.

An example of one such instrument is described, for example, in PCT/GB2019/051510, the entire content of which is incorporated herein by reference. In this example, the segmented quadrupole ion guide 320 may be relatively short, and so ions reaching the mass analyser 304 may not be fully thermalized. The degree of thermalization can affect mass calibration and can depend on factors such as charge state, ion mobility and injection energy.

For example, ions with higher ion mobility will be less influenced by the thermalizing gas, and so will have higher energy, and so greater spatial distribution prior to the (ToF) mass analyser 30.

So, again, the conventional assumption that ions having the same mass to charge ratio (“m/z”) will have the same flight time does not hold (because of different initial positions for ions of different ion mobility but the same mass to charge ratio (“m/z”)).

It is therefore beneficial to calibrate these ions depending on their attribute and/or characteristics. These effects may also be present on higher performance instruments, for example with lower mass accuracy targets.

Various embodiments are also applicable to arrangements in which ions are input to the mass analyser 30 (or to one or more of the one or more upstream functional stages 20) with different energies, that is, where ions have different input energies. For example, in experiments (such as “shotgun” experiments, for example as described in U.S. Pat. No. 6,717,130, the entire content of which is incorporated herein by reference), where the energy of ions is switched or varied (such as being ramped) into a fragmentation device such as a collision cell, the ions leaving the fragmentation device (collision cell) may have different residual energies, and so different spatial distributions prior to the (ToF) mass analyser 30.

So, again, the conventional assumption that ions having the same mass to charge ratio (“m/z”) will have the same flight time does not hold (because of different initial positions for ions of different input energy but the same mass to charge ratio (“m/z”)).

As described above, in various embodiments, different groups of ions in analyte ion data are identified (such as different charge state, different regions of mobility, different multidimensional data regions, different input energy), and a different calibration is used for each different group.

In various embodiments, one or more of the groups may overlap in the first physico-chemical property (mass to charge ratio (“m/z”)). That is, the ions within different groups may be spread across the same range or overlapping ranges of the first physico-chemical property. Nevertheless, the Applicant has recognised a number of ways in which ions within each group can be identified.

For example, in the case of the attribute being charge state, for one-dimensional (such as mass to charge ratio (m/z)) data, peak detection may be used on a mixed spectrum to pick out which ions are singly, doubly, triply charged, and so on. For example, singly charged ions may have isotopes spaced at 1 Da, doubly charged ions may have isotopes spaced at ½ Da, triply charged ions may have isotopes spaced at ⅓ Da, and so on. Ions of each charge state may be grouped together, and a different calibration may be used for each group of ions.

For two-dimensional (such as m/z-mobility) data, different charge states may be distinguished based on their characteristic m/z-mobility distribution. In the case of the attribute being ion mobility, a different calibration may be applied to different regions of mobility or to different regions of m/z-mobility space.

More generally, for multidimensional data (such as m/z-mobility) data, a different calibration may be applied to different regions of the multidimensional data (such as different regions of m/z-mobility space).

Thus, for example, as shown in FIG. 4, a first calibration may be used for Region 1 (which has a first range of mass to charge ratio and a first range of ion mobility drift time) and a second different calibration may be used for Region 2 (which has a second different (overlapping) range of mass to charge ratio and a second different (overlapping) range of ion mobility drift time). More generally in such data, different calibrations may be used for different mass to charge ratio (m/z) ranges, different ion mobility drift time ranges, or for different m/z-mobility regions of the data.

Embodiments are also applicable to Parallel Accumulation Serial Fragmentation (PASEF) type experiments or similar, where different groups of fragment ions are obtained from different parent ions, and where the groups of fragment ions are separated in drift time corresponding to the drift time separation of parent ions. In this case, a different calibration may be used for each group of fragment ions.

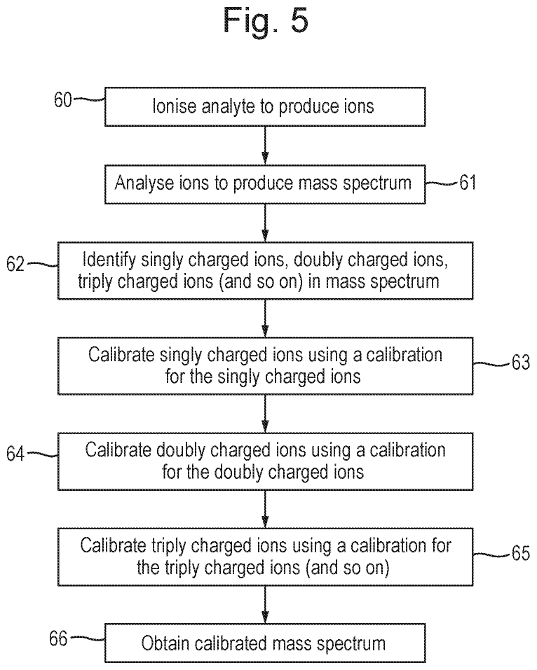

FIG. 5 is a flow diagram illustrating a method of calibrating an analytical instrument in accordance with various embodiments.

As shown in FIG. 5, in accordance with various embodiments, an analyte is ionised so as to produce analyte ions (step 60 in FIG. 5). This may be done using the ion source 10.

The analytical instrument may then be used to measure a physico-chemical property (such as mass to charge ratio, time of flight, (ion mobility) drift time and/or collision cross section (CCS)) of the analyte ions. (Additionally or alternatively, the analytical instrument may be used to measure the physico-chemical property of product or fragment ions derived from the calibrant ions.) Thus, the first physico-chemical property may comprise mass, mass to charge ratio, time of flight, ion mobility, (ion mobility) drift time, and/or collision cross section (CCS).

This may comprise passing ions from the ion source 10 through the one or more functional components 20, and into the analyser 30. The ions (and/or product or fragment ions derived from the ions) may then be analysed by the analyser 30, for example so as to produce a mass spectrum and/or an ion mobility spectrum of the analyte ions (and/or of product or fragment ions derived from the analyte ions) (step 61 in FIG. 5).

Thus, the data set may comprise a mass and/or ion mobility spectrum, and using the analytical instrument to measure a physico-chemical property of the ions (and/or of product or fragment ions derived from the ions) may comprise using the analytical instrument to produce a mass spectrum and/or an ion mobility spectrum of the analyte ions (and/or of product or fragment ions derived from the analyte ions).

The analytical instrument may be used to measure a single physico-chemical property, in which case the data set may be a one dimensional data set such as a mass and/or ion mobility spectrum. Alternatively, the analytical instrument may be used to measure plural physico-chemical properties, in which case the data set may be a multi-dimensional data set such as a two-dimensional mass to charge ratio and ion mobility data set. A two-dimensional mass to charge ratio and ion mobility data set may be obtained, for example, by separating ions in an ion mobility separator before analysing them in the mass analyser 30.

Once the data set has been obtained, at least a first group of ions may be identified within the data set. In various embodiments, plural different groups of ions may be identified within the data set. Some, most or all of the ions within the data set may be assigned to a group. Each ion that is assigned to a group may be assigned only to a single group.

All of the analyte ion(s) within a group may each have the same value of an attribute or may each have a value of the attribute that is within a particular range of the attribute. Thus, analyte ions within the first group will each have a value of the attribute that corresponds to a first value or that is within a first range of the attribute, analyte ions within the second group may each have a value of the attribute that corresponds to a second value or that is within a second range of the attribute, analyte ions within a third group may each have a value of the attribute that corresponds to a third value or that is within a third range of the attribute, and so on.

Each of the values (the first value, second value, third value (and so)) may be different. Each of the ranges (the first range, second range, third range (and so)) may be different. Some or most or all of the ranges may be distinct (non-overlapping) and/or some or most or all of the ranges may partially overlap.

The (first) attribute may comprise a second different physico-chemical property (that is, a physico-chemical property that is not the same as the first physico-chemical property) such as mass, charge, mass to charge ratio, time of flight, (ion mobility) drift time and/or collision cross section (CCS).

In various particular embodiments, the attribute comprises charge (charge state). In these embodiments, the first group of ions may comprise ions having a particular charge (such as one of singly, doubly, triply, (and so on) charged ions). Thus, identifying the first group of ions within the data set may comprise identifying ions having a particular charge (such as one of singly, doubly, triply, (and so on) charged ions) within the data set. Similarly, the second (third) group of ions may comprise ions having a different charge (such as another one of singly, doubly, triply, (and so on) charged ions). Thus, identifying the second (third) group of ions within the data set may comprise identifying ions having a particular different charge (such as one of singly, doubly, triply, (and so on) charged ions) within the data set.

As described above, the step of identifying a group of analyte ions within the data set may comprise subjecting the data set (spectrum) to a peak-detecting algorithm, in order to identify different groups of ions within the data set, such as singly charged ions and/or doubly charged ions and/or triply charged ions, and so on (step 62 in FIG. 5). Additionally or alternatively, the step of identifying a group of analyte ions may comprise using the measured second physico-chemical property (such as (ion mobility) drift time and/or collision cross section (CCS)) to identify different groups of ions within the data set.

In various particular embodiments, the attribute may comprise (ion mobility) drift time and/or collision cross section (CCS). In these embodiments, the first group of ions may comprise ions having a value of (ion mobility) drift time and/or collision cross section (CCS) within a particular range. Thus, identifying the first group of ions within the data set may comprise identifying ions having a value of (ion mobility) drift time and/or collision cross section (CCS) within a particular range within the data set.

Similarly, the second (third) group of ions may comprise ions having a value of (ion mobility) drift time and/or collision cross section (CCS) within a particular different range. Thus, identifying the second (third) group of ions within the data set may comprise identifying ions having a value of (ion mobility) drift time and/or collision cross section (CCS) within a particular different range within the data set.

As described above, this may be done by using the measured (ion mobility) drift time and/or collision cross section (CCS)) to identify different groups of ions within the data set (where the (ion mobility) drift time and/or collision cross section (CCS) of the ions is measured when measuring the first physico-chemical property (mass to charge ratio) of the analyte ions).

For multidimensional data (such as m/z-mobility) data, a different calibration may be applied to different regions of the multidimensional data (such as different regions of m/z-mobility space).

Thus, all of the analyte ion(s) within a group may each have the same value of a first attribute (such as ion mobility value and/or collision cross section) or may each have a value of the first attribute that is within a particular range of the first attribute. All of the analyte ion(s) within a group may also each have the same value of a second different attribute (such as mass to charge ratio and/or time of flight) or may each have a value of the second attribute that is within a particular range of the second attribute.

Each identified group of analyte ions may then be calibrated using a calibration specific to that group. This may comprise correcting the measured first physico-chemical property of the ions within each group using the calibration associated with that group.

Thus, for example, as shown in FIG. 5, singly charged ions may be calibrated using a calibration associated with singly charged ions (step 63), doubly charged ions may be calibrated using a calibration associated with doubly charged ions (step 64), triply charged ions may be calibrated using a calibration associated with triply charged ions (step 65), and so on.

The results of these multiple corrections may be combined to produce a final, calibrated data set (step 66). Thus, in various embodiments, the data set (the measured first physico-chemical property) may be calibrated using multiple calibrations (including at least the first and second calibrations) to obtain a calibrated data set.

Various embodiments are also directed to methods in which plural calibrations are determined for an analytical instrument, such as the analytical instrument described above. According to various embodiments, this may comprise ionising one or more calibrant(s) so as to produce ions, and using the analytical instrument to measure the first physico-chemical property of the ions. The method may comprise: for each reference value of a first group of plural reference values of the first physico-chemical property, determining a difference between the reference value and a measured value of the first physico-chemical property associated with that reference value, and determining a first calibration for the analytical instrument using the differences. The method may comprise: for each reference value of a second group of plural reference values of the first physico-chemical property, determining a difference between the reference value and a measured value of the first physico-chemical property associated with that reference value, and determining a second calibration for the analytical instrument using the differences.

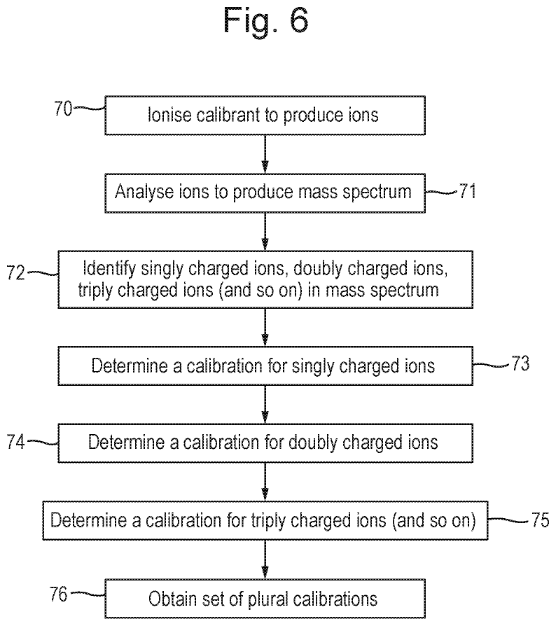

FIG. 6 is a flow diagram illustrating a method of determining plural calibrations for an analytical instrument in accordance with various embodiments.

As shown in FIG. 6, in accordance with these embodiments, a calibrant compound may be ionised so as to produce calibrant ions (step 70 in FIG. 6). This may be done using the ion source 10.

The analytical instrument may then be used to measure the first physico-chemical property (such as mass to charge ratio, time of flight, (ion mobility) drift time and/or collision cross section (CCS)) of the calibrant ions. (Additionally or alternatively, the analytical instrument may be used to measure the physico-chemical property of product or fragment ions derived from the calibrant ions.)

Using the analytical instrument to measure the first physico-chemical property of the ions (and/or of product or fragment ions derived from the ions) may comprise passing the calibrant ions from the ion source 10 through the one or more functional components 20, and into the analyser 30. The ions (and/or product or fragment ions derived from the ions) may then be analysed by the analyser 30, for example so as to produce a mass spectrum and/or an ion mobility spectrum of the calibrant ions (and/or of product or fragment ions derived from the calibrant ions) (step 71 in FIG. 6). Thus, using the analytical instrument to measure the first physico-chemical property of the ions (and/or of product or fragment ions derived from the ions) may comprise using the analytical instrument to produce a mass spectrum and/or an ion mobility spectrum of the calibrant ions (and/or of product or fragment ions derived from the calibrant ions).

The data set (spectrum) may be subjected to a peak-detecting algorithm in order to determine a set of measured values, for example where each measured value corresponds to (the centre of) an ion peak in the spectrum. Thus, using the analytical instrument to measure the first physico-chemical property of the ions (and/or of product or fragment ions derived from the ions) may comprise determining a set of measured values.

At least a first group of ions may then be identified within the data set. In various embodiments, plural different groups of ions may be identified within the data set. All of the analyte ion(s) (measured values) within a group may each have the same value of the attribute or may each have a value of the attribute that is within a particular range of the attribute (for example, as described above with respect to FIG. 5). Optionally all of the analyte ion(s) (measured values) within a group may also each have the same value of a second different attribute or may each have a value of the second attribute that is within a particular range of the second attribute (for example, as described above).

For example, as shown in FIG. 6, a first group of ions (measured values) corresponding to singly charged ions, a second group of ions (measured values) corresponding to doubly charged ions, and/or a third group of ions (measured values) corresponding to triply charged ions (and so on) may be identified in the data set (spectrum) (step 72 in FIG. 6).

In accordance with various embodiments, each of plural reference values of the physico-chemical property (such as each of plural reference values of mass to charge ratio, time of flight, (ion mobility) drift time and/or collision cross section (CCS)) for the selected calibrant may be compared to the measured values of the physico-chemical property of the ions. In particular, the analytical instrument may assign a (single) measured value of the physico-chemical property to each of plural of the reference values of the physico-chemical property. In other words, for each of plural of the reference values, the analytical instrument may find the (single) measured value of the set of measured values that corresponds (most closely) to the reference value.

Thus, for example, the analytical instrument may assign a (single) ion peak in the mass and/or an ion mobility spectrum to each reference value of some or all of the reference values. This may be done, for example by the control system 40, using one or more appropriate algorithms.

The plural reference values may comprise one or more groups of reference values, for example where all of the reference values within a group may each correspond to ions having the same value of the attribute or having a value of the attribute that is within a particular range of the attribute (for example, as described above). Optionally, all of the reference values within a group may each correspond to ions having the same value of a second different attribute or having a value of the second attribute that is within a particular range of the second attribute (for example, as described above).

Plural different calibrations for the analytical instrument may then be determined. Each calibration may be determined by, for each of some or all of the reference values within each group of reference values, determining a (percentage) difference between the reference value and the measured value that has been assigned to that reference value, and then using these difference to determine the calibration for that group for the analytical instrument. A calibration profile such as a calibration curve for the analytical instrument may then be determined using the differences.

A calibration may be determined in this manner for each of the identified groups. Thus, for example, as shown in FIG. 6, a calibration may be determined for singly charged ions (step 73), a different calibration may be determined for doubly charged ions (step 74), a different calibration may be determined for triply charged ions (step 75) (and so on), until a set of plural calibrations is obtained (step 76).

Once a set of plural calibrations has been determined, the calibrations may be stored, for later use to calibrate the instrument. As described above, the calibrations may be used by ionising an analyte so as to produce analyte ions, and using the analytical instrument to measure the physico-chemical property of the analyte ions (and/or of product or fragment ions derived from the analyte ions). The calibration(s) may be used to correct the measured physico-chemical property values of the analyte ions (and/or of the product or fragment ions derived from the analyte ions).

Although various embodiments have been described in detail above, various additional and alternative embodiments are possible.

For example, according to various embodiments, the calibration can be applied in real time or in post processing.

According to various embodiments, the different calibrations in respect of each group can be “dead reckoned” and/or applied generally without full recalibration routines. For example, a calibration could be determined only for singly charged ions, and a correction factor could be applied (together with the determined calibration for the singly charged ions) when calibrating doubly charged ions. This is possible, since as shown in FIG. 3, the calibrations may differ only by a constant correction factor. Thus, in various embodiments one or more or each calibration of the plural calibrations may or may not comprise a (full) calibration curve.

According to various embodiments, corrections may be applied without measuring the attributes of ions, but based on known and/or expected ions in targeted experiments. Thus, identifying each group of analyte ions within the data set (wherein analyte ions within each group each have a value of an attribute that corresponds to a particular value or that is within a particular range of the attribute) may (or may not) comprise measuring, estimating and/or inferring the attribute.

Although various embodiments have been described above in terms of mass to charge ratio calibration (in particular drift time versus mass to charge ratio calibration), for example to calibrating the mass scale of a ToF mass analyser 30, various embodiments are also applicable to different types of calibration. For example, in various embodiments, multiple calibrations may be used for drift time versus ion mobility calibration.

A collision cross section (CCS) calibration may be determined by extracting an arrival time distribution (ATD) from the measured data for each reference mass to charge ratio value, and determining a drift time for each reference mass to charge ratio value from the respective ATD. These drift time values may then be plotted against reference collision cross section values, and a curve may be fitted to this data. This curve may then be used to convert a measured analyte drift time value to collision cross section.

It will be appreciated that various embodiments provide a method comprising applying different calibrations to ions with different attributes.

Various particular embodiments comprise measuring a population of ions with a Time of Flight Mass Spectrometer (“ToFMS”), identifying ions with specific attributes and/or characteristics, and applying calibrations based on said attributes and/or characteristics.

According to various embodiments, the conventional calibration routine is modified to include ions with a range of attributes, where the calibration routine identifies ions with these different attributes and calibrates ions grouped according to different attributes separately. For example, the calibration routine may operate on spectra derived from a mixture of singly and double charged ions and calculate different calibration curves for the singly charged series and doubly charged series.

Future analyte measurements may include determining the attributes of the ions of interest to determine which calibration to apply. Thus, during calibration, re-calibration and mass measurement process, the other attributes of the ions are determined and ions are grouped together before calibration and/or mass measurement

Various embodiments can enable high mass accuracy measurements (<100 ppb) and/or increased or maintained accuracy in smaller instruments.

Although the present invention has been described with reference to preferred embodiments, it will be understood by those skilled in the art that various changes in form and detail may be made without departing from the scope of the invention as set forth in the accompanying claims.

1. A method comprising:
measuring a first physico-chemical property of analyte ions so as to produce a data set;
identifying a first group of analyte ions within the data set, wherein analyte ions within the first group each have a value of an attribute that corresponds to a first value or that is within a first range of the attribute;
selecting, from a plurality of different calibrations, a first calibration associated with the first value or first range of the attribute; and
calibrating the measured first physico-chemical property of the first group of analyte ions using the first calibration.

2. The method of claim 1, further comprising:
identifying a second different group of analyte ions within the data set, wherein analyte ions within the second group each have a value of the attribute that corresponds to a second different value or that is within a second different range of the attribute;
selecting, from the plurality of different calibrations, a second calibration associated with the second value or second range of the attribute; and
calibrating the measured physico-chemical property of the second group of analyte ions using the second calibration.

3. A method comprising:
measuring a first physico-chemical property of analyte ions so as to produce a data set;
using a first calibration to calibrate the measured first physico-chemical property of a first group of the analyte ions; and
using a second different calibration to calibrate the measured first physico-chemical property of a second different group of the analyte ions.

4. The method of claim 2, wherein:
analyte ions within the first group each have a value of a second attribute that corresponds to a first value of the second attribute or that is within a first range of the second attribute; and/or
analyte ions within the second group each have a value of the second attribute that corresponds to a second different value of the second attribute or that is within a second different range of the second attribute.

5. The method of claim 3, further comprising using one or more third different calibrations to calibrate the measured first physico-chemical property of one or more third different groups of the analyte ions.

6. The method of claim 1, wherein the method comprises calibrating the data set using multiple different calibrations to obtain a calibrated data set.

7. The method of claim 1, further comprising determining a plurality of different calibrations for an analytical instrument, where each calibration of the plurality of different calibrations is associated with a respective different value or range of the attribute.

8. A method comprising:
ionising a calibrant so as to produce ions;
using an analytical instrument to measure a first physico-chemical property of the ions;
for each reference value of a first group of reference values of the first physico-chemical property, determining a difference between the reference value and a measured value of the first physico-chemical property associated with that reference value, and determining a first calibration for the analytical instrument using the differences; and
for each reference value of a second group of reference values of the first physico-chemical property, determining a difference between the reference value and a measured value of the first physico-chemical property associated with that reference value, and determining a second calibration for the analytical instrument using the differences.

9. The method of claim 8, wherein:
reference values within the first group of reference values correspond to ions which have a value of an attribute that corresponds to a first value or that is within a first range of the attribute; and
reference values within the second group of reference values correspond to ions which have a value of the attribute that corresponds to a second different value or that is within a second different range of the attribute.

10. The method of claim 8, further comprising:
for each reference value of a third group of plural reference values of the first physico-chemical property, determining a difference between the reference value and a measured value of the first physico-chemical property associated with that reference value, and determining a third calibration for the analytical instrument using the differences;
wherein reference values within the third group of reference values correspond to ions which have a value of the attribute that corresponds to a third different value or that is within a third different range of the attribute.

11. The method of claim 1, wherein the first physico-chemical property comprises mass to charge ratio, time of flight, ion mobility and/or collision cross section.

12. The method of claim 1, wherein the first physico-chemical property comprises mass to charge ratio and/or time of flight, and the step of measuring the first physico-chemical property of the ions comprises mass analysing the ions so as to produce a mass and/or time of flight spectrum.

13. The method of claim 12, wherein the step of measuring the first physico-chemical property of the ions comprises mass analysing the ions using a Time of Flight (“ToF”) mass analyser.

14. The method of claim 1, wherein the attribute comprises a second different physico-chemical property.

15. The method of claim 1, wherein the attribute comprises charge state, wherein ions within each group have the same charge state, and wherein each group corresponds to a different charge state.

16. The method of claim 1, wherein the attribute comprises ion mobility and/or collision cross section.

17. The method of claim 16, wherein ions within each group have an ion mobility value and/or collision cross section within the same range, and wherein each group corresponds to a different ion mobility and/or collision cross section range.

18. The method of claim 1, wherein the attribute comprises energy.

19. An analytical instrument configured to perform the method of claim 1.

20. The analytical instrument of claim 19, wherein the analytical instrument comprises a mass and/or ion mobility spectrometer.
